(19) United States
(12) Patent Application Publication
(10) Pub. No.: US 2008/0020733 A1
(43) Pub. Date: Jan. 24, 2008

(54) MOBILE ELECTRONIC DEVICE WITH MOTION DETECTION AUTHENTICATION

(76) Inventor: Tomas Karl-Axel Wassingbo, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/459,043

(22) Filed: Jul. 21, 2006

(51) Int. Cl. H04M 1/66

(52) U.S. Cl. 455/411

(57) ABSTRACT

A mobile electronic device which may prompt a user to authenticate to the mobile electronic device by drawing a graphic symbol, such as a signature, using the mobile electronic device. An acceleration module generates an acceleration signal representing user motion of the mobile electronic device. A lock circuit for enables operation of a function of the mobile electronic device in response to the acceleration signal indicating that the user motion deviates from reference motion data by no more than a predetermined threshold.

### TECHNICAL FIELD OF THE INVENTION

The present invention relates to mobile electronic devices and in particular to systems and methods for authenticating a user of a mobile electronic device and unlocking functions of the mobile electronic device.

### DESCRIPTION OF THE RELATED ART

Portable radio communication equipment, including mobile telephones, portable data assistants (PDAs), and other mobile electronic devices have been generally available for several years.

It has been recognized that the portability of portable radio communication equipment put such devices at a heightened risk for loss or theft. More specifically, because such devices are carried by a person, they are easily lost and easily stolen. Further, such loss or theft put such devices at risk of unauthorized use of the device's communication services and unauthorized access to data stored on the device. Because.

To reduce the risk of unauthorized use of the device's communication services and/or unauthorized access to data, most portable radio communication equipment includes a password protection system. A typical password protection system is implemented by disabling the keypad, the telephone circuits, and/or the data applications unless and until the user enters an applicable unlock code.

Generally the password/unlock code is in the form of alpha numeric text which may be entered using the keypad of the mobile electronic device. There exist several challenges with such alphanumeric password/unlock code protection systems.

First, the protection provided by a password only exists so long as the password is not compromised. Many people tend to use passwords that are easily guessed, write their passwords on paper, and otherwise compromise the integrity of their passwords.

Second, user entry of a password (and the associated key strokes needed to reach the password entry prompt and active the electronic device after password entry) can be time consuming and aggravating to the point where many people select the option of disabling the password protection of the mobile electronic device.

An alternative system used to password protect a mobile telephone is disclosed in U.S. Pat. No. 6,351,634 to Shin. The system of Shin is useful for a mobile telephone that includes a touch screen. A registered secret symbol is used as the password. The secret symbol comprises a stroke number value responsive to the existence of pressure applied to the touch screen and X/Y coordinate values for each stroke. In operation, a user inputs a symbol using the pressure sensitive touch screen to draw the various strokes of the secret symbol. The device determines whether the input symbol matches the registered secret symbol and unlocks the telephone if the character stroke number value and the X/Y coordinate value signals match that of the secret password symbol. Shin teaches that the secret password symbol can be a character, a signature, a numeral, or a combination thereof.

One challenge with the system of Shin is that it requires that the mobile telephone have a touch sensitive display for free form entry of the symbol. Most mobile telephones do not include a touch sensitive display—making the technology inappropriate for such devices. A second challenge of the system of Shin is that so long as someone can duplicate the secret password symbol, whether by tracing or careful drawing on the touch screen, such person has access to the mobile telephone. Stated another way, authentication of the user is based on the user being able to duplicate the strokes and shape of the secret password symbol.

In a completely separate field of technology, character recognition has been proposed for use as a means for user input of character data into a computer system. For example, U.S. Pat. No. 6,188,392 to O'Connor discloses an electronic pen device that is coupled to a computer system by an RF transmitter or a batch communication docking station. The electronic pen device includes a combination of a pressure sensitive tip (for detecting contact with a surface) and accelerometers for detecting movement of the electronic pen device while in contact with the surface. Data from the accelerometers and the pressure sensitive tip are used to recognize each of a sequence of characters input by the user.

While it may be possible to use the electronic pen device of O'Connor with a mobile telephone, such a system would include several drawbacks. First, such a system would be relatively expensive compared to a traditional mobile telephone or even the mobile telephone of Shin. Such a system would require the need for separate processing systems for both the mobile telephone and the pen, separate batteries, complimentary communication systems (whether by RF or docking station), and other duplicate components. Secondly, use of a discrete external electronic pen with a mobile telephone would be cumbersome at best for a user. The user would need to handle and maintain two separate devices.

What is needed is a mobile radio device that includes systems and methods for authenticating a user of the mobile radio device, and unlocking its communication functions and data storage capabilities, that does not suffer the disadvantages of traditional character based password protection systems, the disadvantages of systems such as in Shin or O'Connor.

### SUMMARY

A first aspect of the present invention comprises a mobile electronic device which enables a user to authenticate to the mobile electronic device and enable a function of the mobile electronic device by drawing a graphic symbol, such as a signature, using the mobile electronic device.

The mobile electronic device comprises an acceleration module generating an acceleration signal representing user motion of the mobile electronic device. A lock circuit enables operation of a function of the mobile electronic device in response to the acceleration signal indicating that the user motion deviates from reference motion data by no more than a predetermined threshold.

The lock circuit may comprise an integration module and an executable authentication process. The integration module integrates the acceleration signal with respect to time to generate a velocity signal and a displacement signal. The executable authentication process: i) compares a representation of the displacement signal and the velocity signal to the reference motion data, the reference motion data comprising reference displacement data and velocity data; and ii) enables operation of the function of the mobile electronic device if the representation of the displacement signal and the velocity signal deviate from the reference displacement data and velocity data by no more than a predetermined threshold. The reference motion data may represents a user's signature and the user motion represents the user moving the electronic device in a signature motion.

The acceleration module may include at least two acceleration detectors for detecting acceleration within a two dimensional plane or a three dimensional space. As such, the velocity signal and the displacement signal represent velocity and displacement of the mobile electronic device within the two dimensional plane or three dimensional space.

The process of comparing a representation of the displacement signal and the velocity signal to reference displacement data and velocity data may include: i) determining a sequential set of displacement coordinate values within the two dimensional plane or three dimensional space from the displacement signal, the sequential set of displacement coordinate values representing sequential positions of the acceleration module within the two dimensional plane or three dimensional space at sequential time increments; ii) comparing the sequential set of displacement coordinate values to a reference set of coordinate values and determining that a symbol shape matches if the sequential set of displacement coordinate values deviates from the reference set of coordinate values by no more than a predetermined threshold; iii) determining a sequential set of velocity vector values within the two dimensional plane or three dimensional space from the velocity signal, the sequential set of velocity vector values representing a speed component and a direction component at each of the sequential set of displacement coordinates; iv) comparing the sequential set of velocity vector values to reference velocity vector values and determining that a velocity model matches if the sequential set of velocity vector values deviates from the reference velocity vector values by no more than a predetermined threshold; and iv) generating the indication of user authentication only if the symbol shape and the velocity model match.

In one sub embodiment, the mobile electronic device may further comprises: i) a key switch system for user control of the mobile electronic device and user data entry; and ii) a display for indicating status of the mobile electronic device and display of data.

In such sub embodiment, the function of the mobile electronic device enabled by the lock circuit comprises a function selected from a group of functions consisting of: i) function of the key switch system; and ii) function of the display system.

In another sub embodiment, the mobile electronic device may further comprise: i) a wireless transmission system for the exchange of wireless data signals with a remote system; ii) a key switch system for user control of the mobile electronic device and entry of user data for transmission to the remote system; and iii) a display for indicating status of the mobile electronic device and display of data received from the remote system.

In such sub embodiment, the function of the mobile electronic device enabled by the lock circuit comprises a communication function between the mobile electronic device and the remote system.

A second aspect of the present invention is to provide a method of enabling a function of a mobile electronic device. The method comprises: i) prompting a user to draw a symbol using the housing of the mobile electronic device; ii) detecting acceleration of the housing of the mobile electronic device within at least two dimensions (e.g. within a two dimensional plane or a three dimensional space) and generating an acceleration signal representing the user drawing the symbol; and iii) enabling operation of a function of the mobile electronic device in response to the acceleration signal indicating that the user motion deviates from reference motion data by no more than a predetermined threshold.

Enabling operation of a function of the mobile electronic device may comprise: i) integrating the acceleration signals with respect to time to generate a velocity signal and a displacement signal; ii) comparing a representation of the displacement signal and the velocity signal to the reference motion data, the reference motion data comprising reference displacement data and velocity data; and iii) enabling operation of the function of the mobile electronic device if the representation of the displacement signal and the velocity signal deviate from the reference displacement data and velocity data by no more than a predetermined threshold. The reference motion data may represents a user's signature and the user motion represents the user moving the the electronic device in a signature motion.

The method may further comprise displaying a reference marker visible on an external portion of the housing of the mobile electronic device, the reference marker indicating a defined portion the housing of the mobile electronic device in which acceleration will be detected and which the user is to use for drawing the symbol.

A third aspect of the present invention is to provide a mobile electronic device for operating as a user authentication client to a remote service provider system. The mobile electronic device comprises: i) a wireless transmission system exchanging wireless data signals with the remote service provider system; ii) an acceleration module generating an acceleration signal representing user motion of the mobile electronic device; and iii) an authentication system.

The authentication system comprises: i) an executable authentication process for receiving a authentication call generated by the remote service provider system and transmitted to the mobile electronic device via wireless signal; and ii) returning a representation of the acceleration signal to the remote service provider system.

In more detail, an integration module may integrate the acceleration signal with respect to time to generate a velocity signal and a displacement signal and the representation of the acceleration signals comprises a representation of the velocity signal and the displacement signal.

The mobile electronic device may further comprising a reference marker visible on an external portion of a housing of the mobile electronic device, the reference marker indicating a defined portion the housing of the mobile electronic device that includes the acceleration module.

A fourth aspect of the present invention is to provide a method of operating a portable electronic device as a user authentication client to a remote service provider system. The method comprising: i) receiving, via wireless signal transmission, an authentication call generated by the remote service provider system; ii) driving an acceleration module to generate an acceleration signal representing user motion of the mobile electronic device; and iii) returning, via wireless signal transmission to the remote service provider system, a representation of the acceleration signal.

The method may further comprise driving an integration module to integrate the acceleration signal with respect to time to generate a velocity signal and a displacement signal. The representation of the acceleration signal may comprises a representation of the velocity signal and the displacement signal.

The method may further include displaying a reference marker visible on an external portion of a housing of the mobile electronic device, the reference marker indicating a defined portion the housing of the mobile electronic device that includes the acceleration module.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1a is a diagram representing an overview of an exemplary embodiment of the present invention;

FIG. 1b is a diagram representing an overview of an exemplary embodiment of the present invention;

FIG. 2a is a diagram representing exemplary placement of a reference marker on exemplary devices in accordance with the present invention;

FIG. 2b is a diagram representing exemplary placement of a reference marker on exemplary devices in accordance with the present invention;

FIG. 3 is a block diagram representing a mobile electronic device in accordance with one aspect of the present invention;

FIG. 4 is a flow chart representing exemplary operation of one aspect of the mobile electronic device accordance with the present invention;

FIG. 5 is a diagram representing exemplary methods for comparing captured displacement and velocity data with reference displacements and velocity data in accordance with one aspect of the present invention; and

FIG. 6 is a flow chart representing exemplary operation of an aspect of the mobile electronic device accordance with the present invention.

### DETAILED DESCRIPTION OF EMBODIMENTS

The term “electronic equipment” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smart phones or the like.

It should also be appreciated that many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

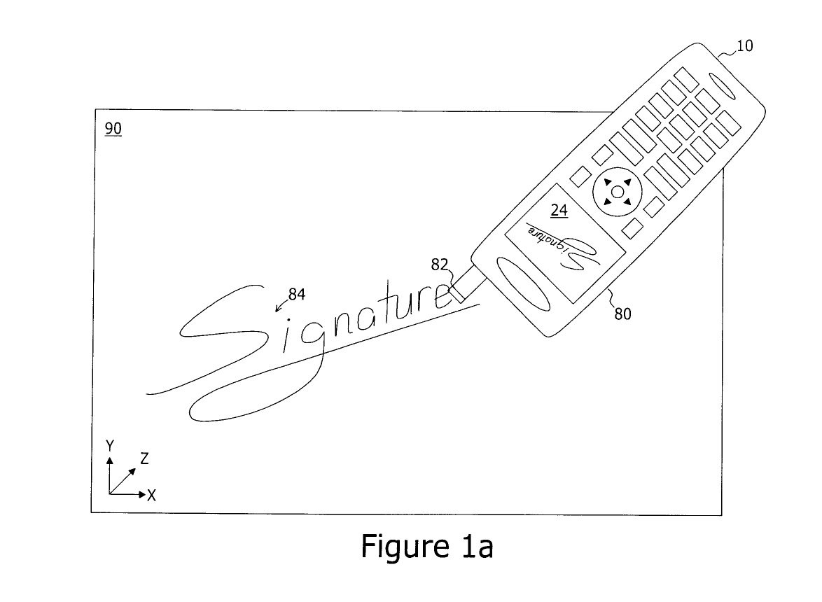

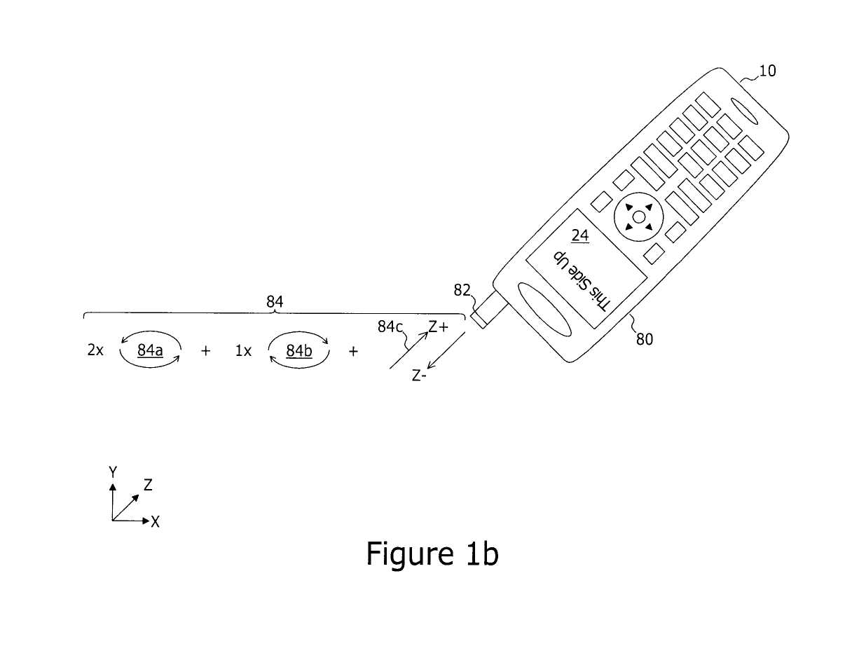

With reference to FIG. 1a, the present invention comprises a mobile radio device 10 that includes an integrated acceleration detection system. The integrated acceleration detection system may be located within a defined portion of the housing (indicated by a reference marker 82) which detects acceleration as a user draws a symbol 84, such as his or her signature within a two dimensional plane such as a flat desk top surface 90 or within a three dimensional space defined by orthogonal coordinates X, Y, and Z. The reference marker 82 does not include an ink pen or a pressure sensitive tip for marking the surface or detecting contact with the surface. The reference marker simply identifies the portion of the mobile radio device 10 that includes the integrated acceleration detection system.

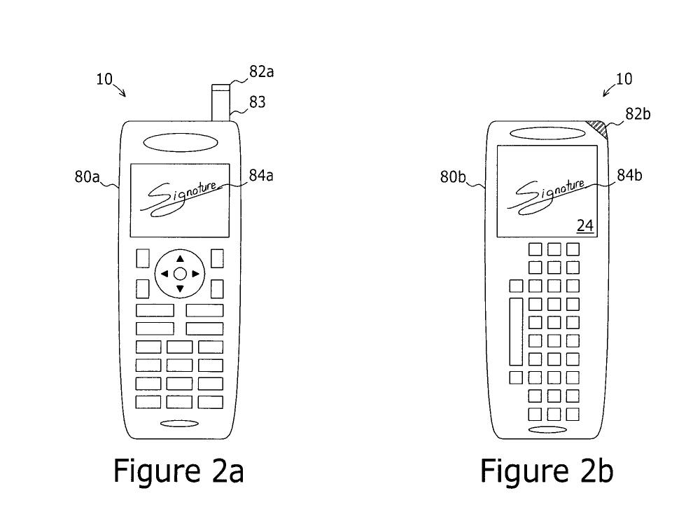

Turning to FIG. 2a in conjunction with FIG. 1a, in one exemplary embodiment, the reference mark 82a may be the top of an antenna 83 which is an intuitive portion of the housing 80 of the mobile electronic device 10 to use for drawing because of the antenna's cylindrical resemblance to a writing instrument. In another exemplary embodiment, shown in FIG. 2b, the reference mark 82b may be a colored mark, surface finish variation, or other indication on a corner of the mobile electronic device 10 which, in the absence of an antenna, is an intuitive portion of the housing 80 of the mobile electronic device 10 to use for drawing because a corner forms a distinct point. In either variation, the shape of the symbol 84 drawn by the user on the two dimensional plane 90 may be shown in “electronic ink” on a display 24 of the mobile electronic device 10.

Returning to FIG. 1a, the mobile electronic device 10 may prompt the user to authenticate to the mobile electronic device 10 by drawing a graphic symbol 84 (virtual drawing the device 10 does not include an ink pen or a pressure sensitive tip for marking the surface or detecting contact with the surface) such as the user's signature, using the mobile electronic device 10.

The acceleration signals are integrated to determine velocity of the integrated acceleration detection system and displacement of the integrated acceleration detection system within the two dimensional plane or three dimensional space. Executable processes compare both the displacement (e.g. shape within the two dimensional plane or the three dimensional space) and velocity (e.g. velocity model within the two dimensional plane or three dimensional space) with reference displacement data and reference velocity data to determine whether the user drawing the symbol 84 is the same user who drew the symbol that was used for generating the reference data. The velocity model reflects the speed used by the user in drawing the symbol 84. Use of the velocity model as part of the authentication system reduces the ability of a person to authenticate by perfectly match the shape of a symbol by tracing or drawing it very carefully and slowly. An indication of authentication and/or unlocking of the mobile radio device 10 occurs if both the shape and velocity model match the reference data.

With reference to FIG. 1b, an alternative embodiment of the present invention is shown. Again, a mobile radio device 10 includes an integrated acceleration detection system. Again, the integrated acceleration detection system may be located within a defined portion of the housing (indicated by a reference marker 82) which detects acceleration as a user draws a symbol 84 within a two dimensional plane such as a flat desk top surface 90 or within a three dimensional space defined by orthogonal coordinates X, Y, and Z.

In this embodiment, the symbol 84 is not necessarily a signature but a sequence of motions that includes two counter clock wise circles of the mobile radio device 10 within the plane defined by the X coordinate and Y coordinate (represented by 84a), one clock wise circle of the mobile radio device 10 within the plane defined by the X coordinate and Y coordinate (represented by 84b), and displacement of the mobile radio device 10 within the direction of the Z coordinate—for example lifting the mobile radio device 10 up from a surface defined by he X coordinate and Y coordinate and then returning the mobile radio device to such surface (represented by 84c).

It should be appreciated that with this type of symbol 84, use of the reference marker 82 for drawing is not critical so long as the mobile radio device 10 is generally positioned in the same manner as when reference data was captured.

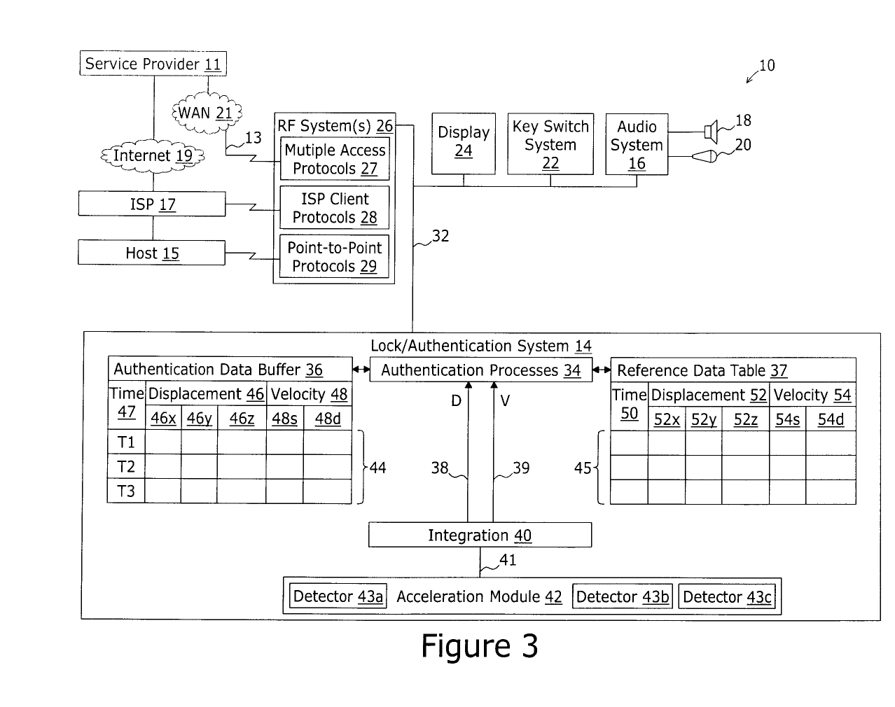

FIG. 3 is a block diagram of an embodiment of a mobile electronic device 10 in accordance with the present invention. Referring to FIG. 3 in conjunction with FIG. 1a, the mobile electronic device 10 includes an RF system 26 for communicating wireless data signals with remote systems.

In one exemplary embodiment, RF systems 26 communicate with tower transmission equipment of a wide area network 21 by implementing a compatible multiple access protocol 27 (e.g. CDMA, CSMA, GSM, etc). In another exemplary embodiment, the RF systems 26 communicate with access point equipment of an Internet Service Provider (ISP) 17 by implementing a compatible ISPP client protocol 28 such as WiFi. In yet another exemplary embodiment, the RF systems 26 communicate with a host computer 15 using a point to point protocol such as blue tooth. It should be appreciate that these exemplary embodiments are for illustrative purposes only. It is envisioned that the mobile electronic device of the present invention may include multiple RF circuits for implementing any combination of the above protocols or similar protocols.

A key switch system 22 and display 24, in combination, provide a user interface to enable user control and use of the mobile electronic device 10. As shown in FIG. 1 a, the key switch system includes a typical numeric keypad along with various function buttons for controlling use of the mobile electronic device 10 as a telephone. In another exemplary embodiment, as shown in FIG. 3, the key switch system includes a typical QWERTY keypad with various function buttons for controlling use of the mobile electronic device 10 as a portable data terminal, two way pager, or similar. In either embodiment the display 24 indicates status of the mobile electronic device 10, prompts and displays user data input, and displays data received from a remote service provider 11. The key switch system 22 enables entry of data for transmission to the remote service provider 11.

An audio system 16 drives operation of a speaker 18 and a microphone 20 for interfacing audio content with a user. In the exemplary embodiment, the audio content represents media session content of a wireless telephone call driven by the service provider system 11. In such embodiment, the audio system 16 receives digital data from the RF system 26, decompresses the digital data to recover audio media initiated by a remote endpoint, and drives the output of such audio media through the speaker 18. The audio system 16 also receives audio media from the microphone 20, digitizes and compresses such audio media, and provides the compressed audio media to the RF system 26 for transmission to the service provider system 11.

A lock/authentication circuit 14 provides security by enabling operation of the mobile electronic device 10 only upon authentication of a user. When in a locked mode, any combination of the keyboard 22, display 24, RF systems 26, and audio system 16 may be disabled to prevent unauthorized use of the mobile electronic device 10. A lock/authentication circuit 14 enables a user to authenticate and drive the lock/authentication circuit 14 to enable operation of the mobile electronic device 10.

The lock/authentication circuit 14 comprises an acceleration module 42 which includes at least two acceleration detectors 43a, 43b (a third acceleration detector 43c is preferred if the symbol 84 is to be drawn within a three dimensional space) which are positioned in the portion of the housing 80 of the mobile electronic device 10 marked for drawing use. The acceleration detectors 43 may be known combinations of accelerometers and solid state gyros for detecting acceleration of such portion of the housing 80 as the user draws the symbol. The acceleration detectors 43a, 43b, and 43c are positioned in an orthogonal relationship for detecting acceleration in both the X direction and the Y direction of the two dimensional plane or the X direction, the Y direction, and the Z direction of the three dimensional space. The acceleration module 42 may also include applicable circuits for digitizing output of the acceleration detectors 43 and controlling gain and dynamic range to produce an acceleration signal(s) 41 for output to an integration module 40.

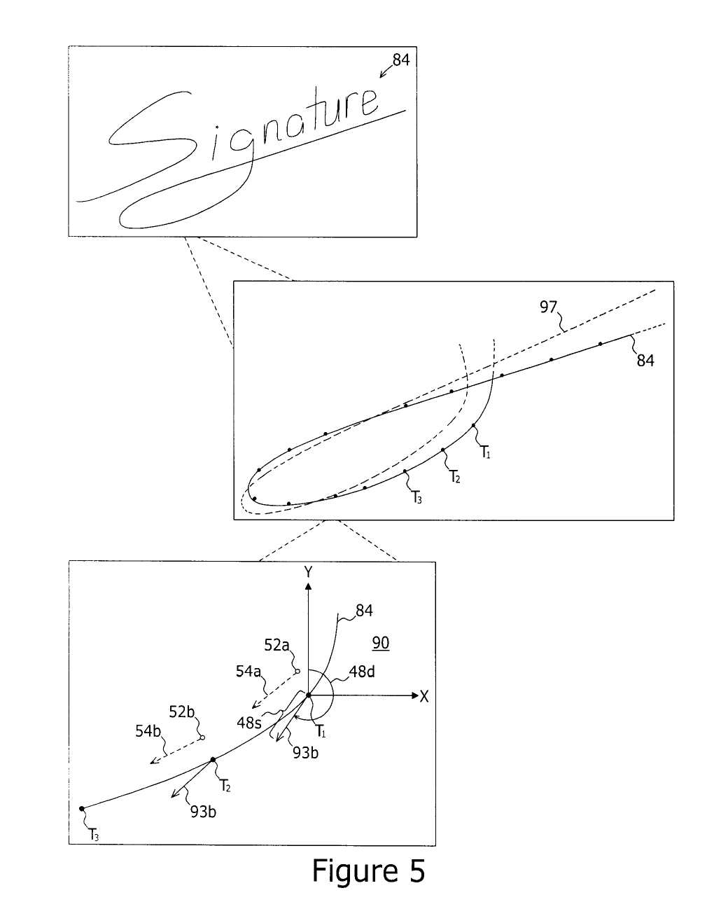

The integration module 40 integrates the acceleration signal(s) 41 with respect to time to generate a velocity signal 39 and a displacement signal 38. Referring briefly to FIG. 5 in conjunction with FIG. 3, as the user draws a symbol 84, the velocity signal 39 indicates the speed 48s (length of a velocity vector 93) and direction 48d (direction of the velocity vector 93 with respect to a reference direction such as the X axis, Y axis, or Z axis) of the portion of the housing 80 (as integrated from the detected acceleration). The displacement signal 38 indicates the position within a two dimensional plane or three dimensional space as defined by an X coordinate 46x, a Y coordinate 46y, and a Z coordinate 46z as integrated from velocity).

The displacement signal 38 and the velocity signal 39 are output to executable authentication processes 34 which populate an authentication data buffer table 36. In more detail, each record 44 of the table 36 includes fields for time 47, displacement values 46 (including the X coordinate 46x, the Y coordinate 46y, and the Z coordinate 46z within the two dimensional plane or three dimensional space), and velocity vector values 48 (including speed 48s and direction 48d). The executable authentication process 34 writes a sequence of records to the table 36 with each record including the displacement values 46 and velocity vector values 48 at a fixed point in time t1, t2, t3 . . . tn.

A reference data table 37 includes a plurality of records 45 each of which includes reference displacement values 52 (including X coordinate values 52x, Y coordinate values 52y, and Z coordinate values 52z) and reference velocity vector values 54 (including reference speed 54s and reference direction 54d) which represents the reference symbol to which the user drawn symbol will be compared. In aggregate the records represent sequential values captured at fixed time increments 50.

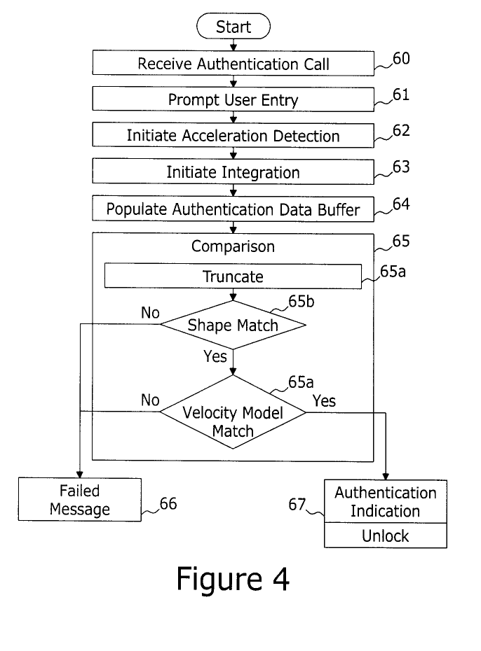

FIG. 4 represents operation of the present invention wherein authentication is used for unlocking the mobile radio device 10. Referring to FIG. 4 in conjunction with FIG. 1a or FIG. 1b and FIG. 3, step 60 represents the lock/authentication circuit 14 receiving an internally generated authentication call to start the authentication/function enablement process and step 61 represents prompting the user to draw the symbol 84 using the portion of the housing 80 of the mobile electronic device 10 that includes the indicator mark 82.

Step 62 represent initiating acceleration detection by the acceleration module 42 and step 63 represents initiating operation of the integration module 40 such that a displacement signal 38 and a velocity signal 39 commence.

Step 64 represents populating records 44 of the authentication data buffer 36. More specifically, at fixed time increments displacement values 46 and velocity vector values 48 are written to the buffer 36.

Step 65 represents comparing a representation of the displacement signal 38 and the velocity signal 39 to the reference displacement values 52 and the reference velocity vector values 54 and, at step 67, generating an indication of user authentication and/or unlocking the mobile electronic device 10 if the displacement signal 38 and the velocity signal 39 deviate from the reference displacement values 52 and the reference velocity vector values 54 by no more than a predetermined threshold.

More specifically, step 65a represents truncating data which is captured prior to the user commencing drawing of the symbol 84. In one embodiment the lock/authentication circuit 14 commences collection of displacement and velocity data after prompting the user to draw the symbol 84. Truncation may be by deleting data prior to the displacement signal 38 matching a shape of the symbol. In this embodiment truncation is independent of any switch or other device for detecting contact with a planar surface. In an alternative embodiment, such truncation may be by deleting data prior to a contact switch or other device indicating that the user has commenced drawing the shape on a planar surface.

Step 65b represents comparing a sequential set of X,Y,Z coordinates (displacement values 46) from the authentication data buffer 36 to reference displacement values 52 from the reference data table 37 and determining that a symbol shape matches if the sequential set of X,Y,Z coordinates from the buffer 36 deviate from the coordinates of the reference displacement values 52 by nor more than a predetermined threshold.

More specifically referring to FIG. 5 in conjunction with FIGS. 3 and 4, step 65b represents determining whether a symbol shape represented by a sequence of displacement values stored in the data buffer, for example coordinates 46x, 46y, and 46z stored in conjunction with time=t1, t2, t3, . . . tn receptively deviate from a model symbol shape represented by sequential reference displacement values 52 stored in the reference table 37. The model symbol shape represented by the sequence of reference displacement values 52 from the reference table 37 is represented by dashed line 97 in FIG. 5.

Step 65c represents comparing a sequential set of velocity vector values 48 from the authentication data buffer 36 to reference velocity vector values 54 from the reference data table and determining that a velocity model matches if the sequential set of velocity vector values 48 from the buffer 36 deviates from the reference velocity vector values 54 by no more than a predetermined threshold.

More specifically referring to FIG. 5 in conjunction with FIGS. 3 and 4, step 65c represents comparing each of a sequence of velocity vector values 48, each at a time increment t1, t2, t3, . . . tn, to a corresponding reference velocity vector value 54 and determining that a velocity model matches if the sequential set of velocity vector values 48 from the buffer 36 deviates from the corresponding reference velocity vector values 54 by no more than a predetermined threshold.

For each velocity vector value 48, the reference velocity vector value 54 used for comparison is the particular reference velocity vector value 54 that is stored in association with displacement values 52 that are most closely aligned with the displacement values 46 associated with the velocity vector values 48 (e.g. stored in the same record in the authentication data buffer 36).

Returning to FIG. 4, generating an indication of user authentication and/or unlocking the function of the mobile electronic device 10 (step 67) occurs only if both the symbol shape and the velocity model match. If either the symbol shape or velocity model fail to match, an authentication failure message is generated at step 66.

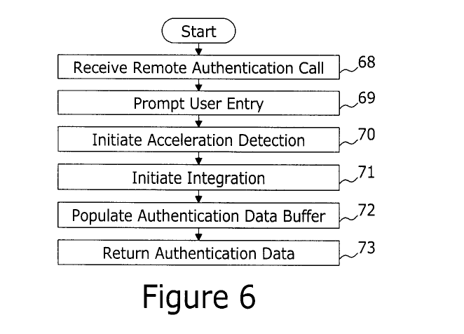

The flow chart of FIG. 6 represents an embodiment of operation of the present invention wherein the mobile radio device 10 is used for authenticating its user to the remote service provider system 11. Referring to FIG. 6 in conjunction with FIG. 1a or FIG. 1b and FIG. 3, step 68 represents the lock/authentication circuit 14 receiving a remote authentication call from the remote service provider system 11 the authentication call being transmitted to the mobile electronic device via the RF system 26.

Step 69 represents prompting the user to draw the symbol 84 (the symbol applicable to the remote service provider system 11) using the portion of the housing 80 that includes the reference marker 82.

Step 70 represent initiating acceleration detection by the acceleration module 42 and step 71 represents initiating operation of the integration module 40 such that a displacement signal 38 and a velocity signal 39 commence.

Step 72 represents populating records 44 of the authentication data buffer 36. More specifically, at fixed time increments displacement values 46 and velocity vector values 48 are written to the buffer 36.

Step 73 represents returning, in response to the remote authentication call, the contents of the records 44 of the buffer 36 (collectively authentication data 44) to the remote service provider system 11 via wireless transmission via the WAN network 21, to the ISP 17 (e.g. wi-fi), or to the host computer 15 (e.g. blue tooth).

Referring again to FIG. 1a and FIG. 1b, it should be appreciated that the structure and functions described herein provide for a convenient system for authenticating a user of a mobile electronic device 10 by signature or other unique symbol 84 drawing within a two dimensional plane or three dimensional space. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A mobile electronic device comprising:
an acceleration module generating an acceleration signal representing user motion of the mobile electronic device;
a lock circuit for enabling operation of a function of the mobile electronic device in response to the acceleration signal indicating that the user motion deviates from reference motion data by no more than a predetermined threshold.

2. The mobile electronic device of claim 1, wherein the lock circuit comprises:
an integration module for integrating the acceleration signal with respect to time to generate a velocity signal and a displacement signal; and
an executable authentication process for:
comparing a representation of the displacement signal and the velocity signal to the reference motion data, the reference motion data comprising reference displacement data and velocity data; and
enabling operation of the function of the mobile electronic device if the representation of the displacement signal and the velocity signal deviate from the reference displacement data and velocity data by no more than a predetermined threshold.

3. The mobile electronic device of claim 2, wherein the reference motion data represents a user's signature and the user motion represent the user moving the electronic device in a signature motion.

4. The mobile electronic device of claim 1:
further comprising:
a key switch system for user control of the mobile electronic device and entry of user data entry;
a display for indicating status of the mobile electronic device and display of data; and
wherein the function of the mobile electronic device enabled by the lock circuit comprises a function selected from a group of functions consisting of: i) function of the key switch system; and ii) function of the display system.

5. The mobile electronic device of claim 4, further comprising a reference marker visible on an external portion of a housing of the mobile electronic device, the reference marker indicating a defined portion the housing of the mobile electronic device that includes the acceleration module.

6. The mobile electronic device of claim 5, wherein the lock circuit comprises:
an integration module for integrating the acceleration signal with respect to time to generate a velocity signal and a displacement signal; and
an executable authentication process for:
comparing a representation of the displacement signal and the velocity signal to the reference motion data, the reference motion data comprising reference displacement data and velocity data; and
enabling operation of the function of the mobile electronic device if the representation of the displacement signal and the velocity signal deviate from the reference displacement data and velocity data by no more than a predetermined threshold.

7. The mobile electronic device of claim 6, wherein the reference motion data represents a user's signature and the user motion represent the user moving the electronic device in a signature motion.

8. The mobile electronic device of claim 1:
further comprising:
a wireless transmission system for the exchange of wireless data signals with a remote system;
a key switch system for user control of the mobile electronic device and entry of user data for transmission to the remote system;
a display for indicating status of the mobile electronic device and display of data received from the remote system; and
wherein the function of the mobile electronic device enabled by the lock circuit comprises a communication function between the mobile electronic device and the remote system.

9. The mobile electronic device of claim 8, further comprising a reference marker visible on an external portion of a housing of the mobile electronic device, the reference marker indicating a defined portion the housing of the mobile electronic device that includes the acceleration module.

10. The mobile electronic device of claim 9, wherein the lock circuit comprises:
an integration module for integrating the acceleration signal with respect to time to generate a velocity signal and a displacement signal; and
an executable authentication process for:
comparing a representation of the displacement signal and the velocity signal to the reference motion data, the reference motion data comprising reference displacement data and velocity data; and
enabling operation of the function of the mobile electronic device if the representation of the displacement signal and the velocity signal deviate from the reference displacement data and velocity data by no more than a predetermined threshold.

11. The mobile electronic device of claim 10, wherein the reference motion data represents a user's signature and the user motion represent the user moving the electronic device in a signature motion.

12. A method of enabling a function of a mobile electronic device, the method comprising:
prompting a user to draw a symbol using the housing of the mobile electronic device;
detecting acceleration of the mobile electronic device within at least two dimensions and generating an acceleration signal representing the user drawing the symbol;
enabling operation of a function of the mobile electronic device in response to the acceleration signal indicating that the user motion deviates from reference motion data by no more than a predetermined threshold.

13. The method of claim 12, wherein enabling operation of a function of the mobile electronic device comprises:
integrating the acceleration signal with respect to time to generate a velocity signal and a displacement signal;
comparing a representation of the displacement signal and the velocity signal to the reference motion data, the reference motion data comprising reference displacement data and velocity data; and
enabling operation of the function of the mobile electronic device if the representation of the displacement signal and the velocity signal deviate from the reference displacement data and velocity data by no more than a predetermined threshold.

14. The method of claim 13, wherein the reference motion data represents a user's signature and the user motion represents the user moving the electronic device in a signature motion.

15. The method of claim 14, further comprising:
displaying a reference marker visible on an external portion of the housing of the mobile electronic device, the reference marker indicating a defined portion the housing of the mobile electronic device in which acceleration will be detected and which the user is to user for drawing the symbol.

16. A mobile electronic device for operating as a user authentication client to a remote service provider system, the mobile electronic device comprising:
a wireless transmission system exchanging wireless data signals with the remote service provider system;
an acceleration module generating an acceleration signal representing user motion of the mobile electronic device;
an authentication system comprising:
an executable authentication process for receiving a authentication call generated by the remote service provider system and transmitted to the mobile electronic device via wireless signal; and
returning a representation of the acceleration signal to the remote service provider system.

17. The mobile electronic device of claim 16:
further comprising an integration module for integrating the acceleration signal with respect to time to generate a velocity signal and a displacement signal; and
the representation of the acceleration signal comprises a representation of the velocity signal and the displacement signal.

18. The mobile electronic device of claim 17, further comprising a reference marker visible on an external portion of a housing of the mobile electronic device, the reference marker indicating a defined portion the housing of the mobile electronic device that includes the acceleration module.

19. A method of operating a portable electronic device as a user authentication client to a remote service provider system, the method comprising:
receiving, via wireless signal transmission, an authentication call generated by the remote service provider system;
driving an acceleration module to generate an acceleration signal representing user motion of the mobile electronic device; and
returning, via wireless signal transmission to the remote service provider system, a representation of the acceleration signal.

20. The method of claim 19, further comprising:
driving an integration module to integrate the acceleration signal with respect to time to generate a velocity signal and a displacement signal; and
the representation of the acceleration signal comprises a representation of the velocity signal and the displacement signal.

21. The method of claim 20, further comprising:
displaying a reference marker visible on an external portion of a housing of the mobile electronic device, the reference marker indicating a defined portion the housing of the mobile electronic device that includes the acceleration module.
